(19) United States
(12) Patent Application Publication
(10) Pub. No.: US 2016/0376183 A1
(43) Pub. Date: Dec. 29, 2016

(54) Method and Apparatus for Dewatering of a Flocculated Mass

(71) Applicant: Kenneth W. Cusic, Lexington, KY (US)

(72) Inventor: Kenneth W. Cusic, Lexington, KY (US)

(21) Appl. No.: 15/189,429

(22) Filed: Jun. 22, 2016

Related U.S. Application Data
(60) Provisional application No. 62/183,578, filed on Jun. 23, 2015.

(51) Int. Cl. C02F 11/14; B01D 21/01; B01D 21/00

(52) U.S. Cl. CPC C02F 11/14; B01D 21/0012; B01D 21/0024; B01D 21/01

(57) ABSTRACT

A method of secondary or capillary dewatering of a flocculated mass provides for draining of water from the flocculated mass by means of an apparatus comprising separate and distinctive, interconnected dewatering cones that are placed independently on a false floor within a tank. Cleaning the cones or static devices is simplified and facilitated by quick and easy removal from the tank. After removal of the cones from the tank, removing or recovering a dewatered flocculated mass or dry matter from the tank also is simplified and may be accomplished in a preferred embodiment by opening a gate on the tank and scooping out the resulting dry matter.

### CROSS-REFERENCE TO RELATED APPLICATION

This application claims the benefit of priority under 35 U.S.C. §119(e) from U.S. Provisional Application Ser. No. 62/183,578 filed Jun. 23, 2015, titled “Method and Apparatus for Dewatering of a Flocculated Mass” and the entire contents of which are incorporated by reference herein and should be considered a part of this specification.

### BACKGROUND OF THE INVENTION

Field of the Invention

The invention relates to a method and an apparatus for capillary dewatering of a flocculated mass.

Description of Related Art Including Information Disclosed Under 37 CFR 1.97 and 37 CFR 1.98

U.S. Pat. No. 5,656,174 issued Aug. 12, 1997, by Hodges et al. for Dredging System and Method, U.S. Pat. No. 5,938,936 issued Aug. 17, 1999, by Hodges et al. for “Method for Dewatering Flocculated Materials,” and U.S. Pat. No. 6,149,811 issued Nov. 21, 2000, by Hodges et al. for “Dredging System” disclose a continuous, portable dredging system that employs a series of screens and gravity separation devices with flocculation to remove sediments from the dredged slurry. The system produces a treated water stream having low solids content and a recovered solids product having a low water content.

U.S. Pat. No. 6,652,757 issued Nov. 25, 2003, by Hodges et al. for “Method for High Speed Dewatering of Slurries” discloses a system and method for dewatering a continuous stream of slurry at high flow rates that demonstrates enhanced efficiency, economy and ease of operation. A stream of slurry is subject to continuous or continual measurement of flow rate and pulp density and the measurements are used to control the rate of addition of a flocculating agent to the slurry. The flocculated slurry is delivered to a dewatering unit where it is passed through a diffuser and evenly delivered to a tracking screen for filtering solids from a liquid filtrate. The pulp density of the filtrate may also be measured and used to control addition of a flocculating agent. The tracking screen is adjusted to achieve an angle of repose suited to the particular composition of the filter cake. The diffuser has a base having a horizontal section aspect ratio of from about 1:1 to about 4:1 and continuously changing vertically into an upper portion having a horizontal section with an aspect ratio of from about 40:1 to about 100:1. The ratio of the horizontal sectional areas to the upper portion with respect to the base is from about 1:1 to about 3:1. The dewatering unit of the invention may be adjustably mounted on a transport means for deployment of the high speed dewatering system and method at any convenient location.

U.S. Pat. No. 8,678,200 issued Mar. 25, 2014, by Hodges et al. and U.S. Pat. No. 8,828,242 issued Sep. 9, 2014, by Hodges et al., both for “Apparatus and Method for De-Watering of Slurries” disclose a system for dewatering a stream of slurry that has a first and a second separator. The first separator removes objects above a first size, to produce a stream of primary treated slurry. The second separator removes objects above a second size from the primary treated stream, the second size being smaller than the first size. Optionally, a third separator removes objects above a yet smaller third size from the stream of secondary treated slurry. The first separator has a plurality of sieve mat supports alternately connected to a main support frame section and a movable support frame section so that the flexible sieve mat can be agitated by the movable support frame section, a collector being provided for collecting the primary treated slurry passing through the flexible sieve mat. In an optional step, water contained in the separated solids is removed.

### BRIEF SUMMARY OF THE INVENTION

A method of the present invention for dewatering a flocculated mass comprises the steps of placing a slurry containing a flocculated mass within a tank, which tank has a dewatering apparatus of the present invention within the tank; dewatering the slurry with the apparatus; and discharging capillary water and free water dewatered from the slurry from the tank.

An apparatus used with the method of the present invention to dewater a slurry containing a flocculated mass comprises a tank having a discharge valve; and a dewatering apparatus within the tank; further wherein the dewatering apparatus has multiple, overlapping dewatering zones therein; and further wherein the dewatering zones consist of a primary dewatering zone and a secondary dewatering zone.

### BRIEF DESCRIPTION OF THE SEVERAL VIEWS OF THE DRAWING(S)

FIG. 1 is a cross-sectional, side view of an apparatus of and which apparatus is used with a method of the present invention.

FIG. 2 is a top plan view of an apparatus of and which apparatus is used with a method of the present invention.

FIG. 3 is a cross-sectional, side view of a cone of the apparatus, having a dewatering zone therein, as used with the method of the present invention.

FIG. 4 is a top plan view of a cone of the apparatus used with the method of the present invention.

FIG. 5 is a side view of a cone of the apparatus as used with the method of the present invention.

### LIST OF REFERENCE NUMERALS

2 apparatus

4 outer tank

6 outer tank floor

8 inner tank

10 inner tank floor

12 floor drain zone

14 discharge valve

16 gate

18 cone

20 cone base

22 tether

24 cone eye

26 primary dewatering zone

28 secondary dewatering zone

### DETAILED DESCRIPTION OF THE INVENTION

Flocculate means to cause individual particles, such as of day or other sediment, to aggregate into clot-like masses or to precipitate into small lumps: or to form lumpy or fluffy masses.

Flocculation of fine grain particulates (i.e., clays, organics and other particulates), has been employed as a way of separating water from solids in waterway dredge operations, mining circuits or paper circuits. The flocculation process creates a water-laden cake (much like curds or cottage cheese) and clear water filtrate discharge (having any remaining particulates of approximately <30 mg/ltr).

Traditional equipment used to dewater flocculated masses, such as geo-tubes, plate and frame press, belt press, and centrifuge, have limited throughput, thus creating substantial downtime and high costs of production. These downtime issues and attendant costs can be ameliorated with the use of specific capillary water drainage techniques that greatly enhance production and reduce costs.

Flocculated material within a water-based slurry will drain clear water if shear is minimalized during the drainage process. In all cases where flocculated material is accumulated in a tank or tanks, or is stored in a cell, it is advantageous to release as much capillary water as possible to achieve stackable and truckable solids. A prerequisite to this condition, obtaining a flocculated mass, has been demonstrated in the prior art.

The method of the present invention is advantageous over the prior art in that the method provides for removal of capillary water and free water from a flocculated mass by introducing a static dewatering media that would attract water drainage in a vehicle, such as a tank, so that a transfer media can drain water through a false floor. Such a process is known in the prior art which refers to a “ladder system” apparatus that attracts a local flocculated mass for drainage of water from the mass. However, such an apparatus as articulated in the prior art did not anticipate the degree of difficulty in cleaning the filtration media. The need to clean the filtration media minimized production of the entire prior art system and, thus, productivity was negatively impacted.

Instead of draining water from the flocculated mass, as known in the prior art, a beneficial advantage of the method of the present invention is that the present invention drains water from the flocculated mass with separate and distinctive dewatering zones of the apparatus. These dewatering zones are preferably, substantially cone-shaped, or alternatively may be obelisk-shaped, or pyramid-shaped, and may be continuous-sided or multi-sided, and are referred to herein, regardless of shape, as “cones,” and the cones are placed independently on a perforated metal false floor within a tank. Multiple cones are used with the apparatus of the present invention. The cones also are constructed of perforated metal, are hollow on the inside, have either, preferably, no flooring, or a perforated flooring, and are covered with a geo-synthetic fabric (akin to a plastic carpet) to filter out particulates and that allows for the passage of water, but not particulates or flocculated material, through the fabric and through the perforated metal of the cone.

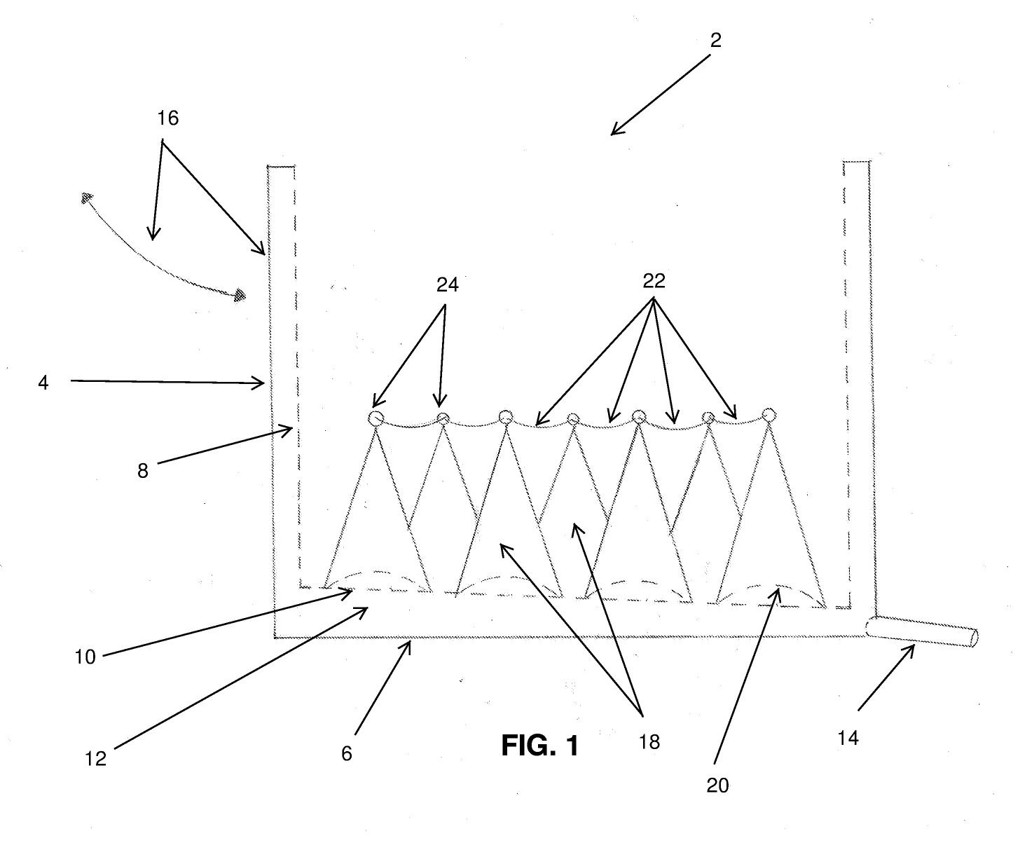

With reference to FIG. 1 and FIG. 2, the cones 18 are interconnected by means of a tether 22 which may be constructed of any suitable materials such as a chain, a cable, a rope or the like. The tether 22 is passed through the cone eyes 24 to interconnect all the cones 18. The cones 18 are placed within an inner tank 8 and are separated from each other by a distance of approximately 36″ between each cone base 20 or tank 8 side. Preferably, two sets of multiple cones 18 are placed side by side in a staggered array within the tank 8. The cones 18 are engineered to have a capillary water drainage circumference of no more than about 18″ from any drainage source. The interconnected cones 18 form a localized dewatering apparatus 2 of the method of the present invention. Each of the cones 18 and all sides of the inner tank 8, comprising the inner tank 8 walls and the inner tank floor 10, are covered with geo-synthetic fabric to maximize filtration of particulates from and dewatering of a slurry containing flocculated masses.

After sufficient drainage of capillary water and free water from the flocculated mass has occurred, the interconnected cones 18 are periodically lifted through the flocculated mass and removed from the tank 8. After removal from the tank 8, the cones 18 are cleaned to remove any remaining, dewatered flocculated mass from the cones 18. Cleaning of the cones 18 or static devices is simplified and facilitates quick removal of the primary, or new, dewatering process.

After the cones 18 are removed from the inner tank 8, the outer tank 4 and the inner tank 8 may be opened by means of a gate 16 and the dewatered, flocculated mass or dry matter remaining in the inner tank 8 may be removed from the tank 8 by any suitable means, such as manually or by means of heavy equipment such as a scoop bucket or front-end loader.

With the method and apparatus 2 of the present invention, large volumes of flocculated masses may be dewatered quickly and efficiently. The apparatus 2 of the present invention allows for at least two to three shifts per day or tank 4, 8 loads of flocculated masses to be dewatered.

As shown in FIG. 1 and FIG. 2, an outer tank 4 of the apparatus 2 of the present invention is relatively large, for example, from about 6′ to about 8′ high, from about 20′ to about 40′ long, and from about 8′, preferably, to about 12′ wide. The outer tank 4 has five sides, comprising four walls and a floor, is open on top and is comprised of a solid material, such as metal, and has no perforations therein. An inner tank 8 has five sides, comprising four walls and a floor, is open on top and is comprised of a solid material, such as metal, but is perforated on all four walls and the inner tank floor 10 to allow for drainage of water from a flocculated mass that is being dewatered. As stated previously, preferably the inner tank 8 walls and the inner tank floor 10 are covered with geo-synthetic fabric to maximize filtration of particulates from and dewatering of a slurry containing flocculated masses. The inner tank 8 fits within the outer tank 4. The perforations within the inner tank 8 are of a sufficient diameter to allow water to drain from the flocculated mass and out the inner tank 8, but to prevent passage of particulates from the flocculated mass through the inner tank 8.

The outer tank 4 has a discharge valve 14 therein through which capillary or free water removed from a flocculated mass is discharged from the outer tank 4. Preferably, the outer tank 4 and inner tank 8 have a gate 16 therein at an end or width side, and opposite a discharge valve 14 side, and which gate 16 swings outward from the outer tank 4 and the inner tank 8. The gate 16 allows the interior of the inner tank 8 to be accessed and a dewatered flocculated mass or dry matter remaining with the inner tank 8 to be removed after completion of a dewatering method of the present invention.

As shown in FIG. 2, an apparatus 2 of the present invention is provided within which is at least a dewatering zone, or cone 18. Also as shown in FIG. 2, there is a false floor or floor drain zone 12 within the inner tank 8. The floor drain zone 12 has at least about 5″ in spacing between the outer tank floor 6 and the inner tank floor 10 and is sloped downward by at least about 5° from a gate 16 end of the outer tank 4 to a discharge valve 14 end of the outer tank 4 in order to allow capillary water and free water dewatered from the flocculated mass to drain out the outer tank 4 through the discharge valve 14. Within the inner tank 8 are numerous dewatering zones 26, 28.

With reference to FIG. 1 through FIG. 5, within the inner tank 8 is at least a primary dewatering zone 26 within the inner tank floor 10 and, when the cones 18 are in place, surrounding each cone 18. Each cone 18 is a secondary dewatering zone 28 which allows passage of capillary water and free water from a flocculated mass through the cone 18 and a cone base 20 and through the inner tank floor 10.

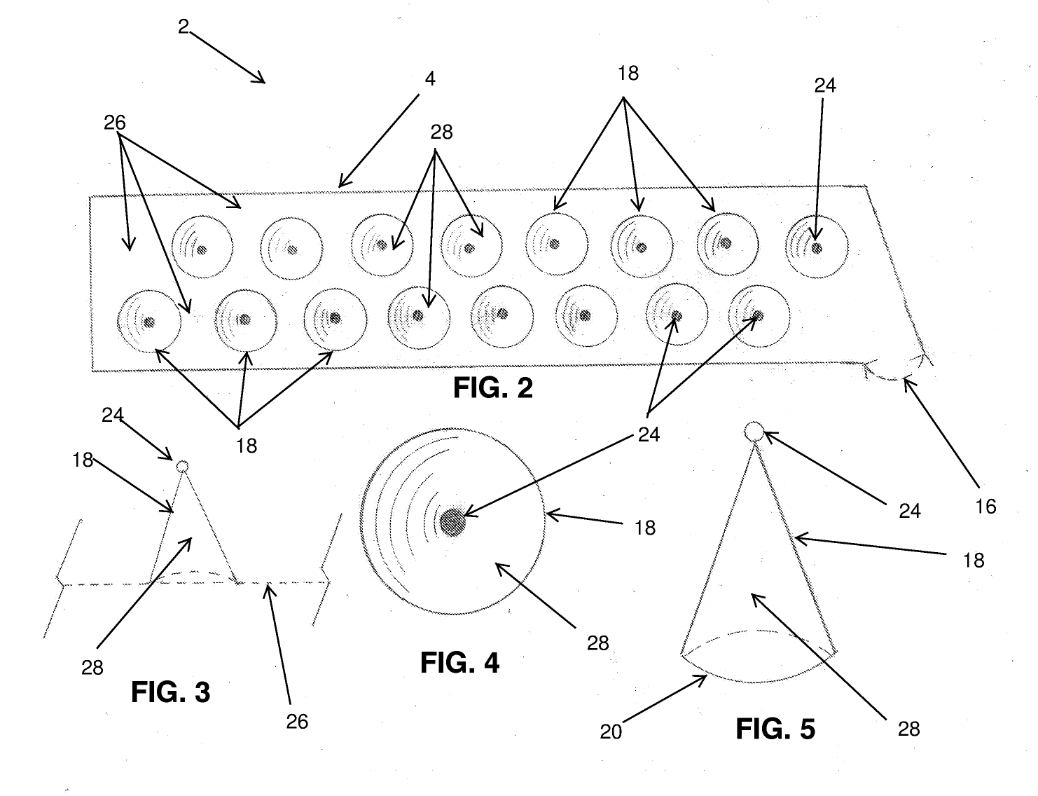

As shown in FIG. 3 and FIG. 4, within the primary dewatering zone 26 is a secondary dewatering zone 28 which is an entire perforated surface area of a cone 18, which has numerous, relatively small openings therein, as well as an open cone base 20.

As shown in FIG. 5, a cone 18 has a cone eye 24 and an open cone base 20. As previously stated, the cone 18 is also a secondary dewatering zone 28 which is an entire perforated surface area of the cone 18 and the open cone base 20. A cone is preferably from about 3′ to about 6′ high and from about 18″ to about 24″ in diameter.

With regard to the method of the present invention, once a mass is flocculated, the mass allows water to more readily pass from the mass. Using the apparatus 2 of the present invention with the method of the present invention allows for a secondary dewatering of a flocculated mass; wherein a primary dewatering has already occurred by known methods in the process of creating the flocculated mass. A flocculated mass is created when a primary dewatering is performed upon a wet mass. The resulting flocculated mass contains capillary water therein. When a flocculated mass has a secondary dewatering performed upon the mass by the method and apparatus 2 of the present invention, the capillary water of the flocculated mass will drain off and it is this secondary dewatering that the method and apparatus 2 of the present invention accomplishes in a relatively fast time. Furthermore, multiple tanks 4, 8 of the apparatus of the present invention can be used together and with interconnecting discharge valves 14 to permit simultaneous secondary dewatering of large volumes of flocculated masses.

In the method of the present invention, a flocculated mass in a slurry is placed in the tank 4, 8. The flocculated mass is allowed sufficient time for dewatering such that the dewatered capillary water and free water is drained from the inner tank 8 into the outer tank 4 and then discharged from the outer tank 4 through discharge valve 14. The cones 18 are then removed from the inner tank 8 by means of the tether 20. For example, a heavy equipment crane with a grabbling hook may grab the tether 20 and lift the cones 18 from the inner tank 8. Alternatively, each cone 18 may be removed one at a time by means of the cone eye 24. After the cones 18 are removed from the inner tank 8, then as previously stated, the gate 16 of the tank 4, 8 may be opened and the dewatered flocculated mass or dry matter recovered for removed from the tank 4, 8.

Although the present invention has been described with reference to specific embodiments, it is understood that modifications and variations of the present invention are possible without departing from the scope of the invention, which is defined by the claims set forth below.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

The invention claimed is:

1. A method of dewatering a flocculated mass comprising the steps of:
a. Placing a slurry containing a flocculated mass within a tank, which tank has a dewatering apparatus within the tank;
b. Dewatering the slurry; and
c. Discharging capillary water and free water dewatered from the slurry from the tank;
further wherein the tank has a discharge valve and the dewatering apparatus within the tank has multiple dewatering zones therein which consist of at least a primary dewatering zone and at least a secondary dewatering zone.

2. The method of claim 1 further comprising the step of removing a dewatered, dry mass from the tank.

3. An apparatus to dewater a slurry containing a flocculated mass comprising:
a. A tank having a discharge valve; and
b. A dewatering apparatus within the tank;
further wherein the dewatering apparatus has multiple dewatering zones therein which consist of at least a primary dewatering zone and at least a secondary dewatering zone.

4. The apparatus of claim 3 further wherein the tank comprises an outer tank and within the outer tank is an inner tank which inner tank is perforated on all sides and covered with geo-synthetic fabric.

5. The apparatus of claim 4 further wherein the primary dewatering zone comprises an inner tank floor and at least a secondary dewatering zone comprises at least a cone.

6. The apparatus of claim 5 further wherein the cone is hollow, perforated and covered with a geo-synthetic fabric.

7. The apparatus of claim 5 wherein the at least one cone is interconnected with at least another cone by means of a tether.

8. The apparatus of claim 3 further wherein the tank has a gate.

9. An apparatus to dewater a slurry containing a flocculated mass comprising:
a. An outer tank having a discharge valve;
b. An inner tank within the outer tank, which inner tank is perforated on all sides and covered with geo-synthetic fabric;
c. At least a cone within the inner tank, which cone is hollow, perforated and covered with a geo-synthetic fabric; and
d. A dewatering apparatus within the tank;
further wherein the dewatering apparatus has multiple dewatering zones therein which consist of at least a primary dewatering zone of the inner tank floor, and at least a secondary dewatering zone of the at least a cone.

10. The apparatus of claim 9 wherein the at least one cone is interconnected with at least another cone by means of a tether.

11. The apparatus of claim 9 further wherein the tank has a gate.
